(19) United States
(12) Patent Application Publication
(10) Pub. No.: US 2003/0185296 A1
(43) Pub. Date: Oct. 2, 2003

(54) System for the capture of evidentiary multimedia data, live/delayed off-load to secure archival storage and managed streaming distribution

(76) Inventor: James W. Masten JR., Seattle, WA (US)

Correspondence Address: James W. Masten, Jr., Suite 300, 19401 40th Avenue West, Lynnwood, WA, 98036, US

(21) Appl. No.: 10/108,321

(22) Filed: Mar. 28, 2002

(51) Int. Cl. H04N 7/12; H04N 7/18

(52) U.S. Cl. 375/240.01; 348/143

(57) ABSTRACT

This system is a unique development of apparatus and enabling software functionality specifically aimed at surveillance and monitoring activities and the statutes and administrative policies that govern them. The system incorporates video and audio capture devices and a conventional computer in which unique software functionality creates an authenticating evidentiary audit trail (frame-by-frame) during an optimal compression process while presenting a live view of the captured video data. This unique and uniquely combined process directly supports many public safety and other security operations with their need for a live monitoring view and a minimum capacity storage archive. The unique data construct also allows for such inventive features as a graphical content catalog to aid in finding captured video and/or audio, the evidentiary analysis functionality of variable speed forward and backward playback and a fully managed storage and distribution sub-system again with incorporated audit and activity tracking.

### STATEMENT REGARDING FEDERALLY SPONSORED RESEARCH OR DEVELOPMENT

This invention was not made by an agency of the United States Government nor under a contract with an agency of the United States Government.

### CROSS-REFERENCE TO RELATED APPLICATIONS: Not Applicable

### BACKGROUND OF THE INVENTION

1. Technical Field

The present invention is a system of software programs that along with several off-the-shelf electronic components and computers, embody methods and apparatus for the evidentiary capture of multimedia (audio and video) data in a surveillance or monitoring application. Further, this system also transfers this information either live or delayed to a secure archival storage facility. From the archival storage facility, the evidentiary data is distributed for review using additional components of the system to provide a fully managed streaming distribution of the evidentiary materials.

The present invention also relates to methods and apparatus for providing functionality to process multimedia data as part of the capture activity whereby recognition of intelligible constructs occurs in near real-time or on a delayed basis. These extracted constructs are transmitted in real-time or on a delayed basis to be compared against databases of similar constructs with the object to find a match between constructs from the captured multimedia stream to the constructs in the remote database.

2.Background of the Invention

In order to provide safe environments (both public and private), efforts are made to employ optical and acoustical (video and audio) monitoring. This activity usually uses conventional television technologies also known as CCTV cameras, microphones and VCRs. Although new technologies such as hard drives and other digital recorders are being employed, the operational aspects of these new technologies are consistent with the conventional CCTV and VCR operational activities.

This invention is the embodiment of technologies that present such new functionality as to significantly change the operational activities of those deployed to provide protection in both public and private efforts to ensure safe environments for the normal activities of life.

It is well known in the prior art to collect video (and/or audio) information from a source such as a video camera (and/or a microphone) which transmits an electronic signal down a wire to a recording device. In the prior art this recording device has been a video (and/or an audio) tape recorder that directly transcribed the video (and/or audio) signal to tape such that when the tape is played an exact copy of the video (and/or audio) signal is reproduced. In the latest evolution of this technology the recording medium has transitioned from tape to a hard disk. But the fundamental aspects of the technology and the process have remained the same.

In the prior art this captured information is collected on the recording medium. When the recording medium is completely overwritten with captured data, it must be changed with another medium cartridge, which is then written on, until it too has no more surface available for new information.

Further, it is well known in the prior art to collect captured optical, or optical and acoustical, information (video and/or audio) represented as analog electronic signals from a source such as a charged coupled device (CCD) camera and an included or additional microphone and to forward that information to a remote device for processing and/or storage. It is also well known in the prior art to process or receive otherwise processed digital information that relates to the optical, or optical and acoustical, information (video and/or audio) and to correlate the digital information with the optical, or optical and acoustical, information (video and/or audio). Additionally, it is well known in the prior art to relate the optical, or optical and acoustical, information (video and/or audio) to the digital information near the camera or the camera and the microphone using such techniques as to reduce the volume (compress) of digital information and then transmit the digital information to a remote device for processing and/or storage.

But it is not known in the prior art to combine several processes into the comparison activity as part of the compression operation to build into the compressed digital data a unique evidentiary audit trail such that the authenticity of the data can later be verified.

As such, it is not known in the prior art to create a live view on the viewing monitor of a local digital processor as part of the capture and compression operation of converting digitized analog signals representing optical and acoustical data.

Further it is not known in the prior art to allow a safety officer viewing the monitor to access a program in the local digital processor that can cause fundamental changes in the operation of the camera and/or the microphone capturing the optical and/or acoustic information. These changes could be the selection of new automatic exposure sub-routines or the selection of manual control with configurable presets for such performance parameters as shutter speed, aperture setting and even signal amplification (the electronic equivalent of film speed).

Additionally, it is not known in the prior art to use the partial products of the comparison operation as part of the compression process to create optimal presets or continuous corrections to the critical control operations of the collection devices (CCD camera or microphone). Then to use the connections to the data collection devices to change their operational parameters to enhance their performance in the presence of nonoptimal physical conditions.

Further it is not known in the prior art to extract (on a regular or irregular interval) typical frames from the compressed stream of evidentiary data (video and/or audio) so that these frames can be searched for recognizable constructs either locally or remotely, in near real-time or on a delayed basis. The recognized constructs can then be transmitted (wired or wireless) to a remote server search engine that compares the constructs to a database of known entities for which the discovery of a match can be in the public or private interest of safety or a reduction in the threats against persons or property.

Still further, it is not known in the prior art that in the process of creating a compressed stream of video and/or audio data with a built-in evidentiary audit trail that the data should be packaged in a form that is directly insertable into a secure archive (transmitted by wire or wirelessly) using automated techniques that require few or no operational activities on the part of the safety personnel. Additionally, it is not known in the prior art that monitoring or surveillance video and/or audio data, collected remotely and compressed with a built-in evidentiary audit trail, is automatically transferred to a secure archive, and is then managed in the storage of the evidentiary data and in the distribution of the evidentiary materials to all classes of viewing and/or listening clients using Internet Protocol (IP) and WEB supporting tools (browsers, and browser delivered programs) across LANs, WANs and the Internet.

Further still, it is not known in the prior art that such browser delivered programs would include technologies that create on a single click a graphical map of the content of the archive for a particular day for a particular camera or microphone.

Similarly, it is not known in the prior art that such browser delivered programs would include technologies to stream both video and/or audio to only those credentialed clients that have met predetermined criteria through a distribution management activity that itself is a browser delivered technology.

Additionally, it is not known in the prior art that during the packaging of the compressed data and the building of the evidentiary audit trail that the data should be packaged such that the relative information content of the data and thus the effective level of compression or the relative amount of sampled data should be controllable as a result of real-time activities either by the safety officer or other measured activities in the real environment of the safety operation where the collection of video and/or audio data serves a desired purpose.

As such it is not known in the prior art that when the managed and approved client is viewing or listening that the player should have the functionality to adapt to the relative change in information content on a smooth basis such that the client is unaware of the gross change. The change could be manifest in several different aspects of the evidentiary materials. As an example, the frame rate of the video could be at a low rate of for example 4 frames per second. In response to a signal input by the safety officer the frame rate might then jump up to 20 frames per second. Such a technique could dramatically reduce the stored data volume, while assuring that the system could affordably be operated on a continuous basis.

Furthermore, it is not known in the prior art that the player system in use by the managed and approved client has the ability (under client control) to smoothly stream the video forward or backward or to step forward or backward through the video for the purpose of examination of the evidentiary material.

In addition, it is not known in the prior art that the player while smoothly displaying video will automatically compensate for any changes in information content, such as frame rate, without losing synchronization with the audio.

Further it is not known in the prior art that such a complete surveillance and monitoring system for the direct support of public and private safety personnel is fully functional and capable whether the captured video and/or audio data is delivered live by wireless connection or delayed through some combination of wired or wireless connectivity.

In addition, it is well known in the prior art to create a system for near same time viewing of optical or optical and acoustic information and to record this information for later viewing. The system components are typically a CCD camera or a CCD camera and a microphone, an analog transmission path, and an analog recording device. Analog recording devices are sequential devices that can not simultaneously play back and record.

It is well known in the prior art to collect captured optical, or optical and acoustical, information represented as analog electronic signals from a source such as a charged coupled device (CCD) camera and an included or additional microphone and to forward that information to a remote device for processing and storage. It is also well known in the prior art to process or receive otherwise processed digital information that relates to the optical, or optical and acoustical, information and to correlate the digital information with the optical, or optical and acoustical, information. However, it is not known in the prior art to relate events in the optical, or optical and acoustical, information to the digital information and/or events contained within the digital information and based on these detected events to automatically recognize relationships and then to cause a new electronic event, either local to a digital processor or remote, through connected networks (which may be wireless), to a digital processor.

### BRIEF SUMMARY OF THE INVENTION

According to one aspect, the invention is an apparatus for receiving optical information concerning an optical scene and storing processed digital information related to said optical information. The apparatus includes a camera adapted to receive the optical information concerning the optical scene, an information processor connected to the camera and adapted to process the optical information and produce processed digital information related to said optical information, and a storage device connected to the information processor and adapted to receive and store the processed digital information.

According to another aspect, the invention is a method for receiving optical information concerning an optical scene and storing processed digital information related to said optical information. The method includes the steps of: a) receiving the optical information concerning the optical scene, b) processing the optical information and producing processed digital information related to said optical information, and c) storing the processed digital information.

According to yet another aspect, the invention is an apparatus for receiving optical information concerning an optical scene and storing processed digital information related to said optical information. The apparatus includes means for receiving the optical information concerning the optical scene, means for processing the optical information and producing processed digital information related to said optical information, and means for storing the processed digital information.

### BRIEF DESCRIPTION OF THE DRAWINGS

FIG. 1 is a schematic diagram of a first embodiment of the present invention.

FIG. 2 is a schematic diagram of a software functionality of the present invention.

### DETAILED DESCRIPTION OF THE INVENTION

At present the preferred embodiment of the invention uses a CCD camera and/or separately acoustic microphones. The camera typically outputs a standard NTSC, 1-volt peak-to-peak analog signal or a YUV digital representation of the optical image. This output optical image representation is collected by an inline frame grabber. This frame grabber is effectively under software control as to the collected frame rate. The digital representation of frames is output to a remote computer, which is typically located very close to the camera.

The microphone is either attached to a wireless transmitter worn by the safety officer such that the analog signal representing the monitored sound is transmitted to a receiver whose output is connected directly to an in-line-digitizing device. The output of the digitizing device is connected to the remote computer. Or the microphone is connected directly to a portable digitizing processor worn by the safety officer with enough local memory to store the digitized sound for an extended period. At the end of the collection period the digitizing device is connected to the remote computer and the digital representations of the monitored sound are output to the remote computer. In the remote computer the digitized representations of the sound are compressed and packaged into a data structure such that they are suitable to be directly incorporated into the archive.

This computer makes use of the custom software developed for the inventive system. The software and the microprocessor in this computer convert the standard digital representation which is an array of numerical representations for every pixel in the image, to both a live view displayed on the monitor of the local processor and a data stream containing the video and audio data in a compressed format while simultaneously building an audit trail into every frame which is then packaged into a data structure also suitable to be directly incorporated into an archival system.

The software of the inventive system combines several high level processes in the low-level operations within the motion detection, validation, verification and compression process.

The unique systems architecture of the inventive system and its extensibility provides sufficient processing capability to deliver extended functionality for any number of cameras in the system.

The motion detection based compression system of the inventive system can deliver software selectable output frame rates from the compression process that range from a minimum of 2 frames per second to a maximum of 30 frames per second. The software selection can be in response to a signal input to the local digital processor. The signal can originate from many sources either manual or automatic. For instance, the public safety officer can operate a switch that inputs a signal to the computer, or the officer could select to turn on his flashing lights, which could also generate a signal to the computer.

The output of the compression/motion processing process of the inventive system is delivered as unique software image format. This format is the .vid format unique to this application. The .vid format is a unique and native streaming video format developed for this inventive system. Sound is captured in standard formats (.wav) packaged to be directly incorporated into the archive structure for searching and streaming playback.

The archival server stores the evidentiary data in files that are organized by a relational database. The software in the archival server can communicate with the remote server by several different protocols.

The most important characteristic of the inventive system is that all control and data use Internet Protocols (IP). As an IP technology, the collected surveillance and monitoring data are associated as elements on the network. This is greatly empowering. It allows the expansion of the network to be nearly unlimited. It also allows the tools of the Internet for permission, allocation, security and viewing to be used to manage the images captured by the inventive system cameras. However, for safety applications a connection to the Internet for the vital connections of the system would be very unusual.

Viewing or listening clients with permission can connect to the archival server over the network connection, which can be the Internet, but for safety applications is usually a LAN. No matter which network connection architecture is used, the review of the surveillance and monitoring data makes use of standard Internet tools.

Viewers are managed by the data base security and the network protocols in the archival server and the connected network. These protocols are structured to require an appropriate user name and password and to limit access to particular cameras on a prearranged basis. The chief administrator who is enabled to create other administrators signs up new viewers. At the time of sign-up, users are enabled to view selected cameras. The administrator can also add new cameras to the system and acknowledge any special features such as pan, tilt and zoom, automated feature recognition or automated motion detection and alert.

With this system an approved client is only required to have a network connected workstation equipped with a browser to see the live or archived images. Live or archived images are viewed using [symbol] Active X Containers [symbol] within the browser and thus are never copied out to be saved on the local disk, or attached to an email. All images are stored in the Archival Server as watermarked (built-in evidentiary audit trail) and time indexed images. Water marking is done as a multi-termed cyclic redundancy check (CRC) performed over the color values of each pixel in the image. If the images are altered in any way, the CRC will give an indication. The purpose of this feature is to offer validation of the integrity of the images and to make the validation procedure robust to changes in lighting.

There is no known existing patent for an image archival or security camera system that operates the way this system does. The result of the specialized motion based processing very close to the camera, the hierarchical architecture of remote computer and the archival server, the network connectivity between the remote computer and the archival server and the extended network connectivity between authorized clients and the archival server create a networked surveillance and monitoring system that is unique in its ability to support public and private safety officers in the pursuit of their duties.

This system is unique because it is the only surveillance and monitoring system that is truly scaleable. With this architecture, as remote computers and sensors (cameras and microphones) are added the processing power goes up linearly with the number of cameras; thus this system has the ability to maintain the compression and packetization of the image data no matter how large (i.e. the number of cameras goes up) the system gets to be. This enables several performance milestones that are not equaled in the security surveillance and monitoring industry, especially when the system is an operational support system of patrol or surveillance vehicles.

The inventive system defaults to recording all of the images, from all of the cameras, all of the time. Also, the inventive system typically compresses 12 hours of full motion video and audio into less than four gigabytes. This is important because it enables all of the storage medium to be optimized computer based on-line storage no matter what the storage requirement.

The distributed architecture and the resulting scalability are very important for future capability. As cameras are added processing power is being added. This gives the inventive system the ability to perform image, voice, feature recognition and many other processing functions right near the camera on the captured image. The resulting images are available to be sent down the connecting network. As a side benefit the resulting images are small because they have been shrunk at the most remote portion of the network. This operates to preserve bandwidth the most. To the inventor's knowledge there is no prior art system that ties the new compression technologies to the remote camera and then takes full advantage of the reduced data volume (from the compression) over the longest part of the network connection.

Finally, the typical remote computer has been packaged with wireless connectivity. While CDPD modems and GPRS cellular systems such as those offered by wireless services (AT&T, Voice Stream and Verizon) can be used to deliver limited functionality, soon new technology (e.g. low earth orbit (LEO) system like that to be offered by Teledesic) will offer sufficient bandwidth to allow continuous real-time connectivity between the remote computers and the archival server. With such a system it is possible to provide remote surveillance and monitoring as an aid to safety officers anywhere. Additionally, the functionality could be extended to monitoring situations such as how crew or passengers behave on aircraft, ships or trains.

The inventive system recording, archival and control server can offer an additional service of automatically overwriting expiring archived images or promoting selected significant images to evidentiary archival. Activation brings up an additional browser screen that offers pull down menus to select facility name, camera number, and date and time interval for migration into the archive.

The system features a further browser interface that offers a means for a system administrator to enter the system and inspect the viewing client history. The system administrator can then review who has directed cameras, set feature alarms or viewed images and monitored sound in the system. The system provides a bi-directional audit trail using cookie and meta-data collection.

Additionally, this system is unique in the support provided to the approved client. A special feature allows the approved client to bring up a calendar that reveals the existence of video and audio, sorted by camera on one-minute boundaries.

The core of this system has application to many activities for overt or covert security surveillance inside or outside of any entity (fixed or mobile)). Potential applications include facilities (e.g. hospitals, construction sites, garages, office buildings, government or military facilities, airports, ports, retail facilities and residential communities) or vehicles (planes, trains and automobiles).

The inventive system can be configured via software selections to deliver to storage any frame rate from two frames per second to thirty frames per second. The trade-off involves captured data vs. bandwidth and storage space. As a compromise, the inventive system can perform a user operation (a switch) or a user configured motion detection in the image. When the switch is set or the motion detection alarm is triggered, the frame rate delivered to storage can automatically move from some slow maintenance rate to a higher rate determined by the use to be optimum for the situation and the value of the captured data.

The inventive system uses several techniques to automate the collection of surveillance and monitoring data and to manage network traffic. The remote computers are configured to automatically “PUSH” the compressed data from the remote computers to the archival server, when they detect its presence. This saves a lot of network traffic and/or allows operation with an intermittent network.

The remote computers are configured for robust operation. They are built with large (>10 gigabyte) hard drives. The remote computer's control software will automatically search for the archival server. When the link is made the remote computers immediately begin to up-load the archived images in the background.

Because the inventive system software functionality is very efficient in its use of the computer's resources, the remote computer has the potential of expanded functionality. The expansion comes about as additional hardware sub-systems are added to the remote computer or connected to it. The addition of a separate component or an integral addition to the remote computer as an extension to the computer has the capability of supporting GPS, CDPD modems, and printers, of monitoring vehicle operations and/or of originating relay closure contacts.

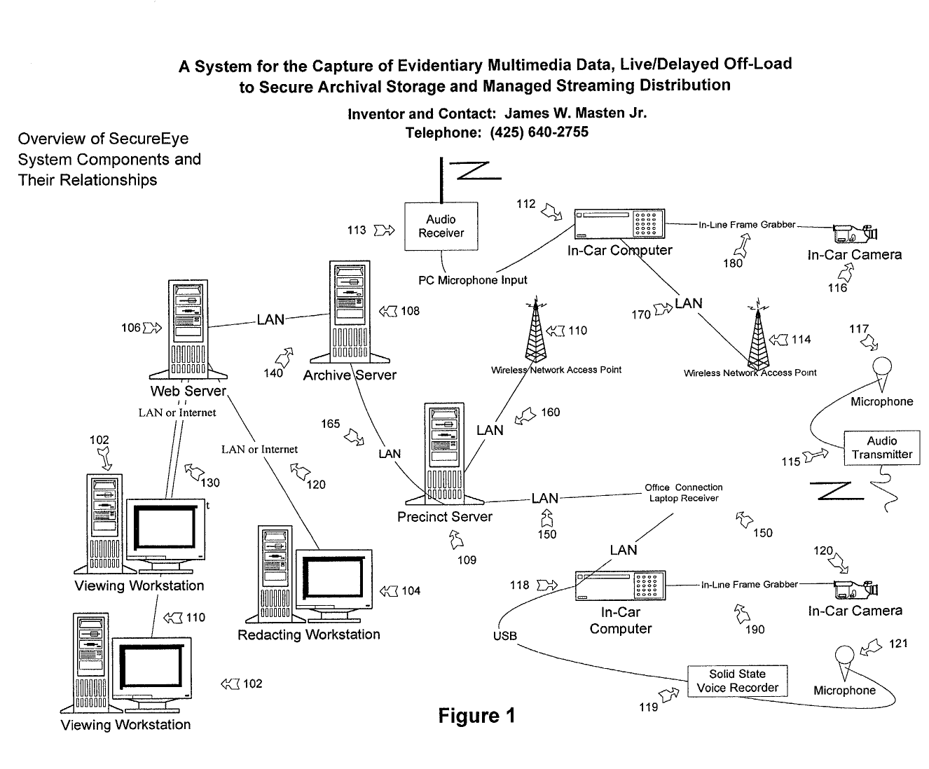

FIG. 1 is a schematic diagram of a first embodiment of the present invention as it applies to the particular application area of police car surveillance camera systems. The inventive system includes a CCD camera 116 and/or 120, an in-line frame grabber 180 or 190, an audio collection system 115 and 117 or 119 and 121 and an in-car computer 112 or 118. It should be noted that in many installations the in-car computer is already in place and performing other functions. Thus, the in-car components supporting the inventive system are minimal. Additionally, the system includes a means for off-loading the captured multimedia data, either a wired LAN 150 or a wireless connection 114/110.

The components outside the car are typically a means for receiving the data either wired 150 or wireless 110/114. The data is collected at high speed through a network connection to a precinct level server 109. The precinct server has sufficient storage capacity and network connectivity to support very high speed simultaneous off-loads for a number of cars as a design goal. The precinct server may be an archival server 108 or it can serve as just a buffer for the archival server, which might be remote to the precinct server.

The archival server 108 can physically share machine resources with the web server 106 or the web server can be a separate machine if additional resources are necessary for sustained operation. The web server acts as host to networked viewing workstations 102. The web server is sized to support as many simultaneous viewing workstations as deemed necessary to support system operation. Additionally, the web server hosts networked connections for redacting workstations 104 that support more detailed analysis and editing of copies of the evidentiary materials intended for outside distribution.

The audio collection system is typically implemented as a body mounted high frequency radio transmitter with an attached lapel microphone. The receiver is located in the car and the audio output of the receiver is connected to the PC through the microphone input. An alternate subsystem uses a solid state voice recorder with a unique software interface that configures the recorder at the beginning of the shift and at the end of the recorder is again connected to the computer through a USB port. The software system will extract the audio and match the sound to the video according to date and time. The back-end of the system is capable of managing audio, video or synchronized audio and video.

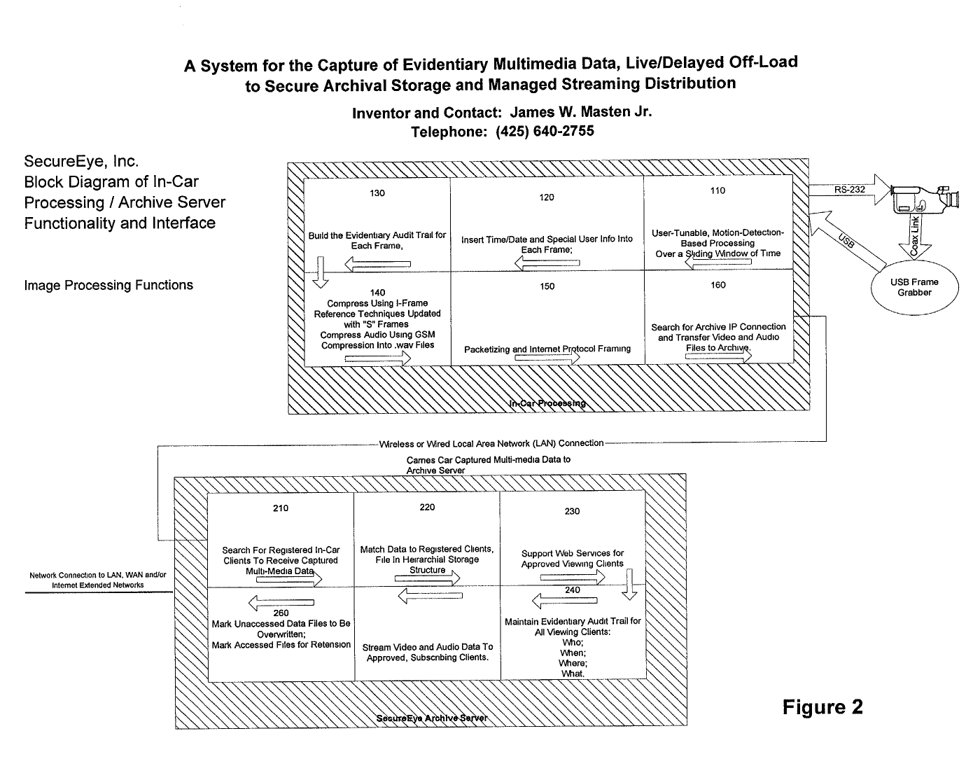

FIG. 2, blocks 110 through 160 show a plan view of the software functionality in operation in the police car. Block 110 depicts the initial processing of the delivered frames in the computer. This operation computes the net motion in each frame against a sliding average of some number of frames, configurable administratively. This process uses the DCT (Discrete Cosine Transform) in a unique operation that yields reference frames in a manner similar to MPEG processing. The process is unique and it produces unique incremental frames, called S-Frames, that give the process unique proprietary capabilities. These capabilities are valuable to the end users in the particular application area of police car surveillance camera applications.

Both the reference frames and the incremental frames are over printed with the date, time and some user configurable data in block 120. The user configurable data can be from some connected sensor. In fact, for one customer, the system has been configured to read the pursuit police vehicle speed and place it in the image field.

In Block 130, the evidentiary audit trail is computed using values from the luminance and chrominance from each pixel in each particular frame. The audit trail numbers are hidden in the user data fields of each frame. But the reference numbers are not necessarily hidden in the user data fields of the frames to which they are keyed. The system can be configured to place the reference numbers in frames addresses which are computed offsets using the date and time of each frame.

Block 140 represents the actual activity of constructing the data stream using the abbreviated representations of reference frames and incremental frames as a result of the administratively configured assembly map (according frame rate of the output). This rate can, in the subject application, change dynamically in response to external switch positions. These switches can be connected to a switch with a primary purpose such as the emergency light bar or to dedicate switches for the purpose of changing the frame rate.

Block 150 represents the activity of creating a data structure for the TCP/IP transfer of the audio and video data from the car to the precinct and archival servers. This process builds the check sums used to verify the transfer of the multimedia data as a successful transfer.

The activity depicted in block 160 is the functionality of examining the wired or wireless network activity of searching the connection for the particular unique IP address.

Blocks 210 through 260 represent the activity of the precinct and archival servers in their support of the data delivery activities from the police cars, the demands of the viewing clients and the support of the redacting clients. Blocks 210 and 220 represent the activity of finding matches to the data collection agents in the police cars to the list of registered data collection agents. A match means the precinct or archival server knows the configuration of the police car data collection activities in the police car and will report an error if the data delivered does not match the data structure predicted in the list.

Block 230 represents the activity of supporting the redacting and viewing clients connecting to the web server on the connected network. The web server tools support the administrators in their efforts to manage and control users and the capabilities granted to each.

Block 240 represents the processes of the archival server and the web servers to check the distributed data for authenticity, the users for activity approval and the age organization of the archived data. Conversely, this same tool structure supports the viewers in their quest to find the existence of the evidentiary materials. The web server distributes through the browser in response to the request of the viewing client a map of the data base organized by pre-configured variables such as badge number, car number, incident number, date or time. The successive detail maps show the granularity of video, and audio on one-minute boundaries.

In Block 250 the activity of the streaming of the data to the viewing clients and the redacting clients is represented. The streaming of the audio and the video data is a unique capability of the inventive system. Streaming allows the viewing client to see the data within the browser while using the Internet Tools to manage and protect the data from unauthorized distribution.

Block 260 represents the maintenance activities of the archival server. The police department establishes the policy of retention and the administrator sets the aging rules for the archival server. Then files that are not accessed during the retention period are marked to be over-written at the end of the retention period. Those files that are accessed before the end of the retention period are permanently retained by the archival system.

While the foregoing is a detailed description of the preferred embodiment of the invention, there are many alternative embodiments of the invention that would occur to those skilled in the art and which are within the scope of the present invention. Accordingly, the present invention is to be determined by the following claims.

What I claim as my invention is:

1. An apparatus for receiving optical information concerning an optical scene and storing processed digital information related to said optical information, comprising:
A camera adapted to receive the optical information concerning the optical scene;
An information processor connected to the camera and adapted to process the optical information and produce processed digital information related to said optical information; and
A storage device connected to the information processor and adapted to receive and store the processed digital information.

2. The apparatus of claim 1, wherein the camera is adapted to interpret the optical information as digital information (of YUV format).

3. The apparatus of claim 1, wherein the information processor processes the optical information to discern a specific optical event taken from a predetermined class of optical events, the processed digital information including an indication of whether the specific optical event is discerned.

4. The apparatus of claim 1, wherein the information processor compresses the optical information.

5. The apparatus of claim 4, wherein the camera produces analog electrical information in response to the optical information and the information processor is adapted to process the analog electrical information and produce the processed digital information in response thereto, the analog electrical information being in a standard format.

6. The apparatus of claim 5, wherein the standard format is the NTSC format.

7. The apparatus of claim 1, wherein there also includes an audio information sensor, whereby audio information is also received.

8. The apparatus of claim 7, wherein a microphone produces an analog electrical signal representing the audio information.

9. The apparatus of claim 7, wherein the information processor also receives the audio information and processes the audio information to discern a specific audio event taken from a class of audio events, the processed digital information including an indication of whether the specific audio event is discerned.

10. The apparatus of claim 9, wherein the camera produces analog electrical information in response to the audio information and the information processor is adapted to process the analog electrical information and produces the processed digital information in response thereto.

11. The apparatus of claim 1, wherein the processed digital information is also related to said audio information.

12. The apparatus of claim 1, further comprising a transmitter connected to the information processor to transmit the processed digital information from the apparatus.

13. The apparatus of claim 1, further comprising a transmitter connected to the storage device to transmit the processed digital information from the apparatus.

14. The apparatus of claim 1, wherein the camera produces electrical information in response to the optical information and the information processor is adapted to process the electrical information and produce the processed digital information in response thereto.

15. The apparatus of claim 14, wherein the electrical information is in a standard format.

16. The apparatus of claim 15, wherein the standard format is the NTSC or YUV format.

17. A method for receiving optical information concerning an optical scene and storing processed digital information related to said optical information, the method comprising the steps of:
a) Receiving the optical information concerning the optical scene;
b) Processing the optical information and producing processed digital information related to said optical information; and
c) Storing the processed digital information.

18. The method of claim 17, wherein step a) includes receiving the optical information as digital information.

19. The method of claim 17, wherein step b) comprises processing the optical information to discern a specific optical event taken from a predetermined class of optical events, the processed digital information including an indication of whether the specific optical event is discerned.

20. The method of claim 17, wherein step b) comprises compressing the optical information.

21. The method of claim 17, further including the step of:
d) receiving audio information.

22. The method of claim 21, wherein step b) further includes receiving the audio information and processing the audio information to discern a specific audio event taken from a class of audio events, the processed digital information including an indication of whether the specific audio event is discerned.

23. The method of claim 17, wherein the processed digital information is also related to said audio information.

24. The method of claim 17, further comprising the step of:
e) Transmitting the processed digital information.

25. The method of claim 17, further comprising the step of:
f) Transmitting the processed digital information after performing step c).

26. An apparatus for receiving optical information concerning an optical scene and storing processed digital information related to said optical information, the apparatus comprising:
A means for receiving the optical information concerning the optical scene;
A means for processing the optical information and producing processed digital information related to said optical information; and
A means for storing the processed digital information.

27. The apparatus of claim 26, wherein the means for receiving the optical information includes means for receiving the optical information as digital information.

28. The apparatus of claim 26, wherein the means for processing the optical information and producing processed digital information includes means for processing the optical information to discern a specific optical event taken from a predetermined class of optical events, the processed digital information including an indication of whether the specific optical event is discerned.

29. The apparatus of claim 26, wherein the means for processing the optical information and producing processed digital information includes means for compressing the optical information.

30. The apparatus of claim 26, further including:
A means for receiving audio information.

31. The apparatus of claim 26, wherein the means for processing the optical information and producing processed digital information includes means for receiving the audio information and processing the audio information to discern a specific audio event taken from a class of audio events, the processed digital information including an indication of whether the specific audio event is discerned.

32. The apparatus of claim 26, wherein the processed digital information is also related to said audio information.

33. The apparatus of claim 26, further comprising:
A means for transmitting the processed digital information.

34. The apparatus of claim 26, further comprising:
A means for transmitting the processed digital information away from the apparatus after the processed digital information has been stored in the apparatus.

35. The apparatus of claim 26, where the digital processing includes the creation of an evidentiary audit trail for each increment of digital data, further comprising:
A means for detection of any alteration or change in any digital representation of the optical information for each frame; and
A means for detection of any alteration or change in any digital representation of the audio information for each increment of time.

36. The apparatus of claim 26, further comprising:
A local display for the user to observe a live view which is created as an early partial product of the digital process of compression and the creation of the evidentiary audit trail.

37. The apparatus of claim 26, further comprising:
A means to accept a local input signal as a means of causing a change in the mathematical process of compression;
A means to change the capture frame rate of the digitized video in response to an input signal using either manual or automated techniques; and
A means for changing the video frame rates smoothly and on the fly as a technique for trading fidelity for storage volume.

38. The apparatus of claim 1, further comprising a means to send signals back to the camera to cause a fundamental change in the process of converting the optical scene to a representative signal either analog or digital.

39. A method for changing the controls of the physical parameters of the camera in response to the quality of the live view or the features of the compressed product, the method comprising:
A means to optimize the camera's capture process for low light operations by limiting the shutter speed to no slower than an administratively configured limit;
A means to optimize the camera's capture process for use in bright light or high glare from either natural or artificial light;
A means to optimize the viewing of highly reflective items in a larger scene of low reflectivity;
A means to change the basis for estimating the illumination of a scene using a portion of the scene for measure; and
A means of limiting the duration of the open shutter to reduce motion blur by giving-up definition of a scene.

40. An apparatus for receiving digital information, storing such digital information and redistributing such digital information comprising:
A receiver for digital information through a wired or wireless connection;
A processor for processing control of the storage and distribution of received digital information;
A storage device connected to the control processor capable of storing digital information;
A transmitter for the distribution of digital information; and
A means for distributing digital information to one or several approved receivers.

41. The apparatus of claim 40, further comprising:
A means to automate the wireless or wired off-load of digital information;
A means to transfer, through a wired or wireless connection, the digital information representing the captured, compressed and audited video and audio information captured and stored in the local processor; and
A means to manage the automated off-load of the captured data such that a minimum of retransmissions is required to assure that no information is lost and all of the information is transferred to the remote storage network.

42. The apparatus of claim 40, further comprising:
A means to seamlessly present the captured digital information in close synchronization with the sound even though the capture frame rate was changed during the capture process;
A means to manage playback rate to automatically maintain close synchronization with the sound and appropriate smooth motion as seen by a local or a remote after-the-fact viewer;
A means to enable single step playback in either forward or reverse direction; and
A means to enable playback in reverse at the same speed at which the video was captured.

43. The apparatus of claim 40, further enabling:
A means to show and distinguish which minutes of which days of which month of which years have either audio, video or both available for playback;
A means by which the indications of the presence of digital data are by color indication; and
A means by which the indications of the presence of digital data are by label indication.

44. The apparatus of claim 40, further enabled by a means to “stream” the evidentiary data (both audio and video) to a qualified viewer such that a file of the evidentiary material never exists on his workstation. Thus, further managing the unauthorized distribution of the evidentiary materials.

45. The apparatus of claim 40, further enabling a qualified distribution agent to use a special software program that will convert the evidentiary materials from a unique format incorporating evidentiary management properties to an industry standard format for editing and further unmanaged distribution.
